(19) United States
(12) Patent Application Publication
(10) Pub. No.: US 2023/0382807 A1
(43) Pub. Date: Nov. 30, 2023

(54) METHOD FOR SINTERING CERAMIC MATERIALS

(71) Applicant: FORSCHUNGSZENTRUM JÜLICH GMBH, Jülich (DE)

(72) Inventors: Apurv DASH, Jülich (DE); Robert MÜCKE, Linnich (DE); Olivier GUILLON, Jülich (DE)

(21) Appl. No.: 18/032,719

(22) PCT Filed: Sep. 13, 2021
(86) PCT No.: PCT/EP2021/075118

§ 371 Date: Apr. 19, 2023

(30) Foreign Application Priority Data
Oct. 30, 2020 (DE) 10 2020 213 680.7

(51) Int. Cl. C04B 35/45; C04B 35/64; H01K 1/04

(52) U.S. Cl. CPC C04B 35/45; C04B 35/64; H01K 1/04; C04B 2235/3282; C04B 2235/3217; C04B 2235/666; C04B 2235/6567; C04B 2235/785; C04B 2235/786

(57) ABSTRACT

A method for producing a densified component and an article comprising a densified component is disclosed. In a method for producing a densified component, a starting material is subjected to an electric field at a temperature (T) below 800° C. The starting material comprises a first material from the group consisting of cuprates. The method has a low technical effort, since densification is possible without heating the starting material.

The invention relates to a method for producing a densified component and to an article comprising a densified component.

Sintering is a method for processing substances. In this, a substance is heated and, if necessary, subjected to an increased pressure so that the substance is densified (compacted). Sintering is performed at high temperatures, which, however, are below the melting temperature of the main components, so that the shape of the workpiece is retained during sintering. Shrinkage typically occurs as the starting material is densified. Sintering produces a solid workpiece, wherein properties such as hardness, compressive strength and thermal conductivity can be influenced by suitable process parameters.

The sintering of ceramic materials is used to produce ceramic components that have many applications in terms of their properties, such as hardness, compressive strength, wear resistance, high-temperature resistance, thermal conductivity and electrical conductivity. Some methods include shaping, in which a green body is produced from starting materials, usually in powder form, drying, if necessary, and then densification. In this, the starting material is subjected to a temperature between 800° C. and 2500° C. Grain growth occurs in this step. Due to the high temperatures, this method is technically complex and energy-intensive. Strong grain growth can lead to undesirable properties of the produced component. In addition, the long duration of the method, ranging from several hours to days, is a significant disadvantage.

To shorten the sintering process, field-assisted sintering was developed, in which heating is performed by means of an electric current. In this method, also known as field-activated sintering, field assisted sintering technology (FAST) or spark plasma sintering (SPS), a direct electric current is passed through the powder to be sintered, which leads to further heating by the Joule effect. In addition, a pressure of 50 MPa up to 400 MPa is built up and sintering takes place under protective gas or vacuum. Compared to conventional sintering, heating is accelerated and can take place at several 100 K/min, for example, so that significantly shorter process times are possible. This process is also technically complex due to the high temperatures well above 800° C. and the high pressures. In addition, it can only be used with materials that have sufficient electrical conductivity at room temperature, which is not usually the case with ceramic substances. To overcome this disadvantage, flash sintering was developed, which is based on a current flow through the ceramic body in combination with external heating. Here, external heating is first applied and, when a specific temperature is exceeded at which the sample becomes sufficiently conductive, a current flow is realized across the sample cross-section. This method is also technically complex. Other methods rely on heating in an oven to increase conductivity before an electric field is applied.

The publication “Oxide Superconductors” by Robert J. Cava from the “Journal of the American Ceramic Society” [1] 5-28, 2000, describes the development of ceramic superconductors with a focus in copper oxide superconductors from the group of cuprates.

The invention is based on the task to provide an improved method for producing a densified component as well as an improved article.

The task is solved by the method according to claim 1 and the article according to the additional claim. Embodiments are given in the subclaims.

A method for producing a densified component serves to solve the task. A starting material comprises a first material from the group consisting of cuprates. The starting material is subjected to an electric field at a temperature T below 800° C. In this way, a densified component is produced from the starting material.

Unlike many other ceramic materials, ceramic materials from the group of cuprates already exhibit electrical conductivity at temperatures below 800° C. This electrical conductivity enables densification by means of an electric field. The method has a low technical complexity, since no heating of the starting material is required for densification. In particular, the method does not comprise heating the starting material in an oven and/or with an external heating device. Furthermore, the materials used are typically oxides and for this reason not susceptible to oxidation. This opens up additional areas of application compared to metals, alloys and other oxidizable materials.

The method serves to produce a densified component. It can also be referred to as sintering. Since sintering usually refers to processes performed at high temperatures, the method is referred to as densification here.

In particular, the electric field is generated by arranging electrodes on different, for example opposite, sides of the starting material and by applying an electric voltage to the electrodes and/or realizing an electric current through the electrodes and the starting material.

The electric field can be generated by a power supply device. This can be designed as a direct voltage or direct current source or as an alternating voltage or alternating current source.

In particular, the electric field strength is steadily increased from zero to a target value. In this process, a sudden increase in the electric current flowing through the starting material may occur due to the electrical conductivity at a certain field strength. In particular, after a sudden increase and/or a peak in the electric current flowing through the starting material, a switch-over is performed from a field-based control to a current strength-based control. The electric current is thus limited. This prevents melting or destruction of the starting material to be densified. Typically, the power supply device is configured to perform such switch-over.

The starting material may be present as a green body (green compact), i.e. as an article preformed from the starting material. The method may comprise shaping (forming) for producing the green body. This serves to produce the green body, in particular from powdered material. The aim may be to achieve a packing density that is as homogeneous as possible, i.e. a uniform mass distribution, throughout the green body. Shaping is carried out in particular by pressing, casting and/or plastic shaping. In this way, geometrically demanding components can be produced.

Alternatively or additionally, the starting material may be present in powder form. This enables a particularly simple and fast method. The starting material can thus be introduced as a powder into a mould and subjected to the electric field in this mould.

Cuprates are ceramic superconductors which are known as high-temperature superconductors due to their comparatively high transition temperature. In particular, the first material is a ceramic superconductor. Chemical compounds that include a copper-containing anion may be referred to as Cuprates. These may be salt-like cuprates that include oxygen in addition to copper. In particular, however, oxides are meant. Typically, the first material is a substance that has a transition temperature above −196° C., the boiling temperature of liquid nitrogen. In particular, the material from the group of cuprates has an electrical conductivity at room temperature that is between that of a good conductor and that of an insulator. Said electrical conductivity of the material can be between 10⁴ S/m and 10⁷ S/m, in particular between 5*10⁴ S/m and 3*10⁶ S/m, preferably between 8*10⁴ S/m and 1.2*10⁵ S/m.

The group of cuprates comprises, among others, LaBaCuO, LaSrCuo, YBaCuO, BiSrCaCuO, BiSrCuOCO, TlBaCaCuO, HgBaCaCuO, HgTlBaCaCuO, BaCaCuO, BaCaCuCO, SrKCuOCl. Here, only the included elements are given, but not the correct stoichiometric ratios.

The group of cuprates comprises, among others, La₄BaCusOi₃, La₂₋ₓBaₓCuO, La_{1,8}Sr_{0,2}CuO₄, YBa₂Cu₃O₇, B₁₂Sr₂Ca₂Cu₃O₁₀, B₁₂Sr₂CaCu₂O₈, B₁₂Sr₂CuO₆, HgBa₂Ca₂Cu₃O₈, HgBa₂Ca₂Cu₃O₉, Y₂Ba₄Cu₇O₁₅, Hg_{0.8}Tl_{0.2}Ba₂Ca₂Cu₃O_{8.33}, Hg₁₂Tl₃Ba₃₀Ca₃₀Cu₄₅O₁₂₇, HgBa₂CaCu₂O₆, T₁₂Ba₂Ca₂Cu₃O₁₀, Pb₂Sr₂YCu₃O₈, Nd₂CuO₄, Ca_{0,84}Sr_{0,16}CuO₂, TlBa₂(Eu,Ce)₂Cu₂O₉, GaSr₂(Y,Ca)Cu₂O₇, Pb₂Sr₂Y₁₋ₓCaxCu₃O₈, Sr₃₋ₓKₓCu₂O₄Cl₂, Sr₂₋ₓKₓCuO₂Cl₂, NbSr₂(Nd,Ce)₂Cu₂O₁₀, (Sr,Ca)CuO₂, YBa₂Cu₃O₇, YBa₂Cu₃O₇₋ₓ, YBa₂Cu₃O₇₋₆, for example with 6 between 0,05 and 0,65, also referred to as YBCO, YBaCuO, Y-123, 123 oxide or 123 compound. In one configuration, the first material is yttrium barium copper oxide. This has a high transition temperature and good availability.

The temperature T means the temperature at the beginning of the effect of the electric field on the starting material. In particular, the starting material is not heated before it is subjected to the electric field. Nevertheless, it is possible that the temperature rises selectively to values above 500° C., 400° C., 300° C., 200° C., or 100° C. due to the effect of the electric field. In particular, however, this temperature is well below 800° C. The temperature T can describe, for example, an average temperature inside the starting material.

In particular, the temperature T is lower than 700° C., lower than 600° C., lower than 500° C., lower than 400° C., lower than 300° C., lower than 200° C., or lower than 150° C. Surprisingly, it has been shown that densification similar to a conventional sintering process is possible at these temperatures. The temperature T is higher than the transition temperature of the starting material and/or the first material. At the transition temperature, the electrical resistance tends abruptly towards zero. At lower temperatures, a short circuit occurs due to the lack of electrical resistance and little or no densification takes place. In particular, the temperature is higher than −150° C., for example higher than −125° C., preferably higher than −100° C., in one configuration higher than −75° C., for example higher than −50° C., in particular higher than −25° C., and in one example higher than 0° C.

In one embodiment, the temperature T is lower than 100° C., in particular lower than 50° C. In one configuration, the temperature is lower than 80° C., lower than 70° C., lower than 60° C., lower than 40° C., lower than 30° C., or lower than 25° C. It may be equal to or lower than room temperature.

In one embodiment, the starting material is subjected to the electric field for a period of time of less than 10 min, preferably less than 1 min.

Experiments have shown that the method according to the invention allows complete densification already within the short period of time mentioned. In terms of the essential parameters such as shrinkage, change in porosity, density increase and/or strength, densification is comparable to conventional methods, which require orders of magnitude more time. Thus, a particularly fast, resource-saving and cost-effective method is provided.

In one embodiment, the starting material is subjected to the electric field under atmospheric pressure.

In other words, the method is carried out without applying pressure. No pressure is built up in addition to the atmospheric pressure. Due to gravity, starting material located further down is subjected to pressure by the starting material located further up in addition to the atmospheric pressure. However, this will be neglected here. In one configuration, the maximum pressure in the starting material at the beginning or shortly before the beginning of the effect of the electric field is less than 1.6 bar, preferably less than 1.4 bar and particularly preferably less than 1.2 bar or less than 1.1 bar.

In one configuration, the starting material is mechanically compacted before the effect of the electric field, in particular by pressing. The starting material can be pressed uniaxially or isostatically. For example, a preform or green body may be produced. In this way, more complex densified components can be produced. The arrangement of electrodes for applying an electrical voltage and/or an electrical current is also possible in a simpler and particularly reproducible manner. In addition, a particularly uniform distribution of the grains and/or pores is ensured, which enables particularly homogeneous densified components.

In a further embodiment, the electric field has an electric field strength greater than 50 V/cm. In particular, the electric field strength is between 100 V/cm and 5 kV/cm. In particular, the mean field strength is meant which acts on the starting material.

When sintering conventional ceramics, the required field strength is lower at higher temperatures and vice versa. Due to the electrical conductivity of the materials from the group of cuprates, this is not the case in the method according to the invention. The required electric field strength increases here with increasing temperature. Thus, densification of a starting material at room temperature may be possible with 300 V/cm, while densification of the same starting material at a temperature of −100° C. only requires a field of 50 V/cm. Here it is necessary to weigh up the advantages and disadvantages of very low temperatures. Although energy savings can be achieved at low temperatures, the cost of any necessary cooling is higher.

In one configuration, the starting material has a mass fraction of the first material from the group of cuprates between 50% and 100%.

In one embodiment, the starting material has a mass fraction of a second material between 0% and 50%.

The second material is different from the first material. In particular, it does not include a cuprate. It has been shown that compression at low temperatures is also possible if only a share of the starting material is a cuprate. This is possible from a cuprate share of about 50%. In this way, a wide range of possibilities are available for adapting the properties of the densified component to the respective requirements by means of suitable admixtures.

In a further embodiment, the second material is an electrically insulating material, in particular a ceramic material.

Until now, such materials could not be densified at low temperatures. Heating to high temperatures of, for example, 1400° C. to 1600° C. has been necessary up to now. The addition of the first material now makes it possible for the first time to densify at low temperature, which is also very fast. The power consumption of the starting material is ensured by the first material. In this way, a wide variety of material compositions with the respective desired properties can be produced and densified by means of different mixtures.

For example, the second material is an aluminium oxide (alumina). Aluminium oxide is a widely used technical ceramic with a wide range of applications. Aluminium oxide has been difficult to sinter up to now because it has electrically insulating properties even at high temperatures. According to the invention, an “indirect” sintering of aluminium oxide is made possible by combining it with cuprate.

In one configuration, the starting material includes a mass fraction between 0% and 99% of a second material and a mass fraction between 0% and 99% of a third material, optionally a mass fraction between 0% and 99% of a fourth material, and, if applicable, a mass fraction between 0% and 99% of a fifth material. The mass fractions of the second, third, fourth and/or fifth material may be below 40%. They may be below 20%. They may be below 10%. They may be below 5%. The second, third, fourth and/or fifth material may be an insulating ceramic material.

In one embodiment, at least a first region, in particular at least a first layer, of the starting material consists essentially of the first material. At least a second region, in particular at least a second layer, of the starting material consists essentially of the second material

In other words, a region-by-region, for example layer-by-layer, arrangement of the two materials is possible. In one configuration, the starting material consists of a first layer and a second layer arranged, in particular, immediately adjacent thereto. In one configuration, the starting material comprises three layers, wherein a second layer is arranged between two first layers. In particular, the three layers are each arranged immediately adjacent. The starting material may consist of the three layers.

In one configuration, a region of the first material is surrounded by second material. Accordingly, a region of the first material is positioned between second material along at least one viewing direction. The second material may be arranged as a coating of the first material. Thereby, the properties of the densified component may be influenced.

In one further embodiment, at least a third region of the starting material comprises a mixture of the first material and the second material. Preferably, the mixture is substantially homogeneous.

Thus, at least one region includes a substantially uniform mixture of two different types of particles, wherein at least one type of the particles are cuprate particles. The third region may consist of the mixture of the first material and the second material. Homogeneous means in particular a uniform mixture of the different particles. In this way, a homogeneous densified component with desired properties can be produced.

In one embodiment, a mean particle size of the densified component is larger by a factor F than a mean particle size of the starting material. The following applies: F<5, in particular F<2, preferably F<1.25.

The mean grain size refers in particular to the average or median value of the grain diameter. The densified components produced by the method described can be recognized in particular by the fact that, in contrast to densified components produced by conventional methods, their grain size does not increase significantly due to the low temperature and the short densification time. In conventional methods, the factor F can be between 50 and 100 or higher. Accordingly, the grain size after densification according to the invention is essentially the same as the grain size before densification. Thus, at same grain sizes, the grain size is substantially smaller for components produced by the method according to the invention. Components with very small grain sizes can be produced using the method according to the invention. The particle sizes can be adjusted to meet specific requirements.

A mean grain size of the starting material and/or the densified component can be between 0.1 μm and 100 μm, preferably between 0.5 μm and 50 μm, particularly preferably between 0.8 μm and 25 μm and, for example, between 1 μm and 10 μm. The average grain size can be determined, for example, by scanning electron microscopy and image data analysis.

A further aspect of the invention is an article comprising a densified component. The densified component has been produced by subjecting a starting material to an electric field at a temperature below 800° C. The starting material comprises a first material from the group consisting of cuprates.

In particular, the densified component has been produced by the method according to the invention. All features, configurations and effects of the method described at the beginning also apply accordingly to the article. Conversely, all features, configurations and effects described herein also apply to the method.

The article may be the component, for example a ceramic superconductor. The article can comprise further elements in addition to the component.

The densified component comprises a material from the group of cuprates. Typically, it has a mean grain size of the densified component that is larger by a factor F than a mean grain size of the starting material, wherein: F<5, in particular F<2, preferably F<1.25. Typically, it is recognizable as a densified or sintered component by its properties. In one embodiment, the component has an average grain size between 0.8 μm and 20 μm, preferably between 1 μm and 10 μm.

In one embodiment, the component is a ceramic superconductor. A ceramic superconductor is a ceramic material whose electrical resistance abruptly tends to zero when the transition temperature is reached or undershot. In particular, the component is a high temperature superconductor. It has been shown that superconductors can be produced in the described manner particularly easily and with little technical effort.

In one embodiment, the article is an electromagnet and the component is arranged as a coil winding of the electromagnet. The electromagnet can generate high magnetic fields with low energy input due to the extremely low resistance-related losses of a superconductor. In particular, the electromagnet a DC magnet.

In one further embodiment, the article is a device for generating light. The article is configured such that the component may be subjected to an electric voltage and/or electric field for the purpose of emitting light. The article may comprise a power supply device for subjecting the component to an electric voltage and/or an electric field. The article may be configured such that the component has a temperature below 0° C. when generating light.

Another aspect is the use of a densified component produced by the method according to the invention or an article according to the invention for generating light, wherein the component is subjected to an electric voltage and/or an electric field such that the component emits light. In particular, this is done at a temperature below 0° C. All features, configurations and effects of the method described at the beginning and the article also apply accordingly to the use.

In the following, exemplary embodiments of the invention are also explained in more detail with reference to figures. Features of the exemplary embodiments may be combined individually or in a plurality with the claimed subject matter, unless otherwise indicated. The claimed areas of protection are not limited to the exemplary embodiments.

The figures show:

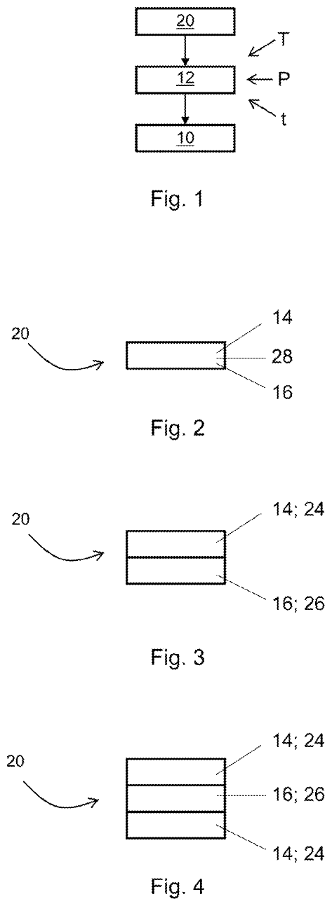

FIG. 1: a method for producing a densified component,

FIG. 2: a first configuration of a component,

FIG. 3: a second configuration of a component, and

FIG. 4: a third configuration of a component.

FIG. 1 schematically shows a method for producing a densified component 10. A starting material 20 is subjected to an electric field 12. In this, the starting material 20 is subjected to a temperature T below 800° C., in particular at the beginning of the effect of the electric field 12. The temperature T typically corresponds to room temperature. In other words, the component is not heated either before or during the action of the electric field 12. The electric field 12 acts for a period of time t of about 30 seconds. No pressure is applied, so that the starting material 20 is subjected to the electric field 12 under the prevailing atmospheric pressure P. The electric field strength is continuously increased, starting from 0 and/or up to a maximum value of 1 kV/cm.

FIG. 2 schematically shows a first configuration of a starting material 20 for producing a densified component. The starting material 20 comprises a third region 28 comprising a homogeneous mixture of a first material 14 from the group of cuprates and a second material 16. In particular, the starting material 20 consists of the third region 28. The second material 16 is different from the first material 14 and in particular does not include a cuprate. Suitable admixtures of the second material 16 can be used to selectively adjust properties of the densified component. At the same time, densification is possible with the method according to the invention.

FIG. 3 shows a second configuration of a starting material 20. The starting material 20 comprises a first region 24 and a second region 26, which are in the form of layers and are directly adjacent to one another. The first region 24 is produced from the first material 14 from the group of cuprates. The second region 26 is produced from the second material 16, which is different from the first material 14 and in particular does not include a cuprate. The coating of the first region 24 with the second material 16 can be done in such a way that properties of the densified component are influenced in a desired manner. For example, a colour temperature of the emitted light may be adjusted in a desired manner.

FIG. 4 shows a third configuration of a starting material 20. The starting material 20 comprises a second region 26, which is sandwiched between two first regions 24, which are in particular of the same type. In particular, the starting material 20 consists of said regions 24 and 26. Again, the first region 24 is produced from the first material 14 from the group of cuprates and the second region 26 is produced from the second material 16, which is different from the first material 14 and in particular does not include a cuprate. The first regions 24 and the second region 26 are arranged in superimposed layers.

The layer thicknesses shown in schematic FIGS. 2 to 4, as well as their ratios, are not to scale. The regions 14 and 16 can have the same or different layer thicknesses. The layer thickness of the first region 14 can be greater than, less than or equal to the layer thickness of the second region 16.

### LIST OF REFERENCE SIGNS

component 10
starting material 20
first material 14
second material 16
first region 24
second region 26
third region 28
temperature T
period of time t
atmospheric pressure P

1. A method for producing a densified component, namely a ceramic superconductor, in which a starting material comprising a first material from the group consisting of cuprates is subjected to an electric field at a temperature (T) below 100° C., wherein the starting material has a mass fraction of the first material from the group consisting of cuprates between 50% and 100%.

2. The method according to claim 1, wherein the temperature (T) is less than 50° C.

3. The method according to claim 1, wherein the starting material is subjected to the electric field for a period of time (t) of less than 10 min.

4. The method according to claim 1, wherein the starting material is subjected to the electric field under atmospheric pressure (P).

5. The method according to claim 1, wherein the electric field has an electric field strength greater than 50 V/cm.

6. The method according to claim 1, wherein the starting material comprises a mass fraction between 0% and 50% of a second material.

7. The method according to claim 6, wherein the second material is an electrically insulating material, wherein the electrically insulating material is a ceramic material such as aluminium oxide.

8. The method according to claim 7, wherein at least one first region, in particular at least one first layer, of the starting material consists essentially of the first material and at least one second region, in particular at least one second layer, of the starting material consists essentially of the second material.

9. The method according to claim 6, wherein at least one third region of the starting material comprises a preferably substantially homogeneous mixture of the first material and the second material.

10. The method according to claim 1, wherein a mean grain size of the densified component is larger by a factor F than a mean grain size of the starting material, wherein: F<5.

11. An article comprising the densified component produced by the method according to claim 1, wherein the article is a device for generating light, wherein the article is configured such that the densified component can be subjected to an electric voltage and/or an electric field for emitting light.

12. (canceled)

13. (canceled)

14. The article according to claim 11, wherein the densified component has an average grain size between 0.8 μm and 20 μm.

15. (canceled)

16. The article according to claim 11, wherein the densified component has an average grain size between 1 μm and 10 μm.

17. The method according to claim 1, wherein the starting material is subjected to the electric field for a period of time (t) of less than 1 min.

18. The method according to claim 1, wherein the electric field has an electric field strength between 100 V/cm and 5 kV/cm.

19. The method according to claim 6, wherein the second material is an aluminium oxide.

20. The method according to claim 6, wherein at least one first region, in particular at least one first layer, of the starting material consists essentially of the first material and at least one second region, in particular at least one second layer, of the starting material consists essentially of the second material.

21. The method according to claim 7, wherein at least one first layer of the starting material consists essentially of the first material and at least one second layer of the starting material consists essentially of the second material.

22. The method according to claim 1, wherein a mean grain size of the densified component is larger by a factor F than a mean grain size of the starting material, wherein: F<2.

23. The method according to claim 1, wherein a mean grain size of the densified component is larger by a factor F than a mean grain size of the starting material, wherein: F<1.25.
